(19) United States
(12) Patent Application Publication
(10) Pub. No.: US 2005/0089123 A1
(43) Pub. Date: Apr. 28, 2005

(54) Circuit method and system for automatic gain control

(76) Inventor: Solon Spiegel, Zurich (CH)

Correspondence Address: Vladimir Sharman C/O Landon & Stark Associates;Suite 210, One Crystal Park, 2011 Crystal Drive, Arlington, VA, 22202-3708, US

(21) Appl. No.: 10/780,891

(22) Filed: Feb. 19, 2004

Related U.S. Application Data
(63) Continuation-in-part of application No. 10/690,842, filed on Oct. 23, 2003.

(51) Int. Cl. H04L 27/08

(52) U.S. Cl. 375/345

(57) ABSTRACT

The present invention is a circuit, method and system for automatic gain control in a communication device which may receive one or more communication signals. The source or sources of the one or more communication signals may be selected from a set of one or more related or unrelated transmitters of networks of transmitters. Each transmitter or network of transmitters may produce one or more signal types. As part of the present invention, a circuit or system may control a gain correction factor of variable gain amplifiers used to amplify a received signal according to a set of parameters associated with one or more selected signal types.

### RELATED APPLICATIONS

The present U.S. Utility Patent Application is a continuation-in-part of U.S. patent application Ser. No. 10/690,842, filed on Oct. 23, 2003, and which is hereby incorporated by reference in its entirety.

### FIELD OF THE INVENTION

The present invention relates generally to the field of communications. More specifically, the present invention relates to automatic gain control (“AGC”) systems, circuits and methods which may be used in conjunction with a multi-system communications device such as a receiver and/or transceiver.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

Modern communication networks are best characterized by features such as high bandwidth/data-rate, complex communication protocols, various transmission medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular networks (e.g. 2G, 3G, CDMA, WCDMA, WiFi, etc.) may be used to supplement coverage for various devices (e.g. cell phone, wireless IP phone, wireless internet appliance, etc.) not connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA and WiFi networks respectively. Signal attenuation and its resulting SNR degradation may limit bandwidth over a transmission medium.

Thus, strong and stable signals are needed for the proper operation of a communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers and variable gain amplifiers (“VGA's”) in order to boost and adjust the strength and/or amplitude of a received signal.

An automatic gain control mechanism (“AGC”) may allow the control of the gain correction factor of a VGA used to boost and adjust a received signal in a closed loop fashion, wherein the AGC may determine a gain correction factor as a function of the strength of the received signal relative to a target signal strength. AGC's associated with receivers of the prior art have been used to dynamically adjust a received signal by an amplification factor which is intended to boost the received signal's strength and/or to compare the detected signal level against a predefined value, minimizing the degradation in the system performance. AGC's of the prior art have typically been associated with a single receiver or set of receivers adapted to receive signals having specific properties related to the signal transmission source or network of related sources, where the basic characteristics of the signal transmitted by each signal sources (e.g. cellular base-stations) were similar. AGC's of the prior art have not been sufficiently flexible to perform efficient automatic gain control on multiple types of signals, having different characteristics and/or parameters, such as might be produced by multiple distinct types of signal sources associated with different and possibly unrelated communication networks.

There exists a need in the field of communications for a system, circuit and method for providing automatic gain control for multiple signals, having different characteristics and/or parameters, such as might be produced by multiple distinct signal sources associated with different and possibly unrelated communication networks.

### SUMMARY OF THE INVENTION

The present invention is a system, circuit and method for providing automatic gain control. According to some embodiments of the present invention, multiple signals, having different characteristics and/or parameters, such as might be produced by multiple distinct signal sources associated with different and possibly unrelated communication networks, may be amplified using variable gain amplifiers (VGA's) and a single automatic gain control unit (“AGC”). Parameters relating to an AGC's operation may be adapted based on the properties of the signal to be received, on the characteristics of the access method of communication networks associated with the signal to be received, and on the operation point of the analog to digital converter unit (ADC) to be used to convert the received signal into a digital data stream.

According to some embodiments of the present invention, an AGC unit may use both feed-forward and feedback information from a given received signal to be amplified. Depending on the signal characteristics and the characteristics of the access medium, either feed-forward, feed-back or a combination of both might be used. The relative weight given to data from the feed-forward and feed-back loops, in order to set the dynamics of the close loop gain control and thus the gain value for a Variable Gain Amplifier (“VGA”), may changing during different stages of a signal's acquisition and/or reception. According to some embodiments of the present invention, one or more VGA's may be used anywhere along a signal's receive path, at one or more frequencies of operation, as in the radio front-end of communication systems.

During initial acquisition of a given signal, an AGC according to some embodiments of the present invention may primarily use information from a feed-forward loop to set an initial gain value. Subsequently, the same or another AGC according to some embodiments of the present invention may primarily use information from a feedback loop to reduce the noise fluctuations of the power estimate of the given received signal.

According to some embodiments of the present invention, especially in situations where short burst signals are to be received, an AGC may primarily use only information from a feed-forward loop to set the gain factor of the VGA. This configuration may allow the AGC to react almost immediately to changes in the received signal level.

According to some embodiments of the present invention, especially in situations where relatively long duration data signals are used, the AGC may primarily use only information from a feed-back loop to set the gain factor of the VGA. In this situation, the AGC may react slowly, but should provide significant noise reduction in the control loop.

According to some embodiments of the present invention, the AGC may primarily use the coarse amplitude information derived directly from the incoming signal to provide an estimate of the signal level.

According to some embodiments of the present invention, an AGC unit may use variable sampling rates, where the sampling rate for updating a signal gain value may be a function of the characteristics of the information signal it is attempting to amplify, of the data rate and of the access medium of the communication network being used. Different signals, produced by different signal sources or networks of sources may be sampled at different sampling rates. Furthermore, according to some embodiments of the present invention, an AGC may sample a given signal at a relatively faster rate during signal acquisition than at other times during the signal's reception.

According to some embodiments of the present invention, each channel of a complex signal (e.g. I channel & Q channel of a complex signal) may be either independently adjusted by the AGC unit, commonly adjusted by the AGC unit or externally adjusted by a controller. According to further embodiments of the present inventions, the bandwidth of one or more filters and circuits along the signal path used to receive the one or more channels of a signal may be adjusted as a function of a gain value determined by an AGC according to some embodiments of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of a multi-mode wireless communication system within which portions of the present invention may be applied;

FIG. 2 shows a block diagram of an exemplary transceiver, including adaptive automatic gain control systems and circuits according to some embodiments of the present invention;

FIG. 3 shows a block diagram of an automatic gain control system, an associated bandwidth control sub-system and associated interface matching subsystem according to some embodiments of the present invention;

FIG. 4 shows a block diagram of an exemplary interface matching sub-system according to some embodiments of the present invention;

FIG. 5 is a graph showing a complex plane onto which a constellation of symbols relating to a complex (e.g. Quadrature Amplitude Modulated) data signal may be mapped. Depicted in the graph of FIG. 5 is an adjustment or remapping which may be performed as part of the present invention to compensate for errors which may result from the separate and/or unequal amplification of separate signal components or channels (e.g. I Channel and Q Channel) of a complex (e.g. QAM) data signal;

FIG. 6 shows a time based graph illustrating the timing of various signals according to some embodiments of the present invention and during three separate signal acquisition and reception phases; and using different dynamics in the close loop automatic gain control unit (AGC).

FIG. 7 shows a graph illustrating signal quantization parameters for an interface matching subsystem according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a system, circuit and method for providing automatic gain control. According to some embodiments of the present invention, multiple signals, having different characteristics and/or parameters, such as might be produced by multiple distinct signal sources associated with different and possibly unrelated communication networks, may be amplified using one or more variable gain amplifiers (VGA's) where a gain factor is provided by the automatic gain control unit (“AGC”). Parameters relating to an AGC's operation may be adapted based on the properties of the signal to be received, on the characteristics of the access method of communication networks, and on the operation point of the analog to digital converter unit (“ADC”).

According to some embodiments of the present invention, an AGC unit may use both feed-forward and feedback loop topologies to set the amplification factor applied to a given signal to be received. Depending on the signal properties and the characteristics of the access medium, either feed-forward, feed-back or a combination of both control loops might be used. The relative weight given to data from the feed-forward and feed-back loops in order to determine a gain value for a Variable Gain Amplifier (“VGA”) may changing during different stages of a signal's acquisition and/or reception. According to some embodiments of the present invention, one or more VGA's may be used anywhere along a signal's receive path, at one or more frequencies of operation, as in the radio front-end of communication systems.

During initial acquisition of a given signal, an AGC according to some embodiments of the present invention, may primarily use information from a feed-forward loop to set an initial gain value. Subsequently, an AGC according to some embodiments of the present invention may primarily use information from a feedback loop to reduce the noise fluctuations of the power estimate of a given received signal.

According to some embodiments of the present invention, an AGC may primarily use only information from a feed-forward loop to set the gain factor of a VGA.

According to some embodiments of the present invention, an AGC may primarily use information from a feed-back loop to set the gain factor of a VGA.

According to some embodiments of the present invention, an AGC may primarily use coarse amplitude information derived directly from the incoming signal to provide an estimate of the signal level.

According to some embodiments of the present invention, an AGC unit may use variable sampling rates, where the sampling rate for updating a signal gain value may be a function of the characteristics of the information signal it is attempting to amplify and of the access medium of the communication network. Different signals, produced by different signal sources or networks of sources may be sampled at different sampling rates. Furthermore, according to some embodiments of the present invention, an AGC may sample a given signal at a relatively faster rate during signal acquisition than at other times during the signal's reception.

According to some embodiments of the present invention, each channel of a signal (e.g. I channel & Q channel of a complex signal) may be either independently adjusted by the AGC unit, commonly adjusted by the AGC unit, or may be adjusted by an external controller. According to further embodiments of the present inventions, the bandwidth of one or more filters and circuits along a signal path of one or more channels of a signal may be adjusted as a function of a gain value determined by an AGC according to some embodiments of the present invention.

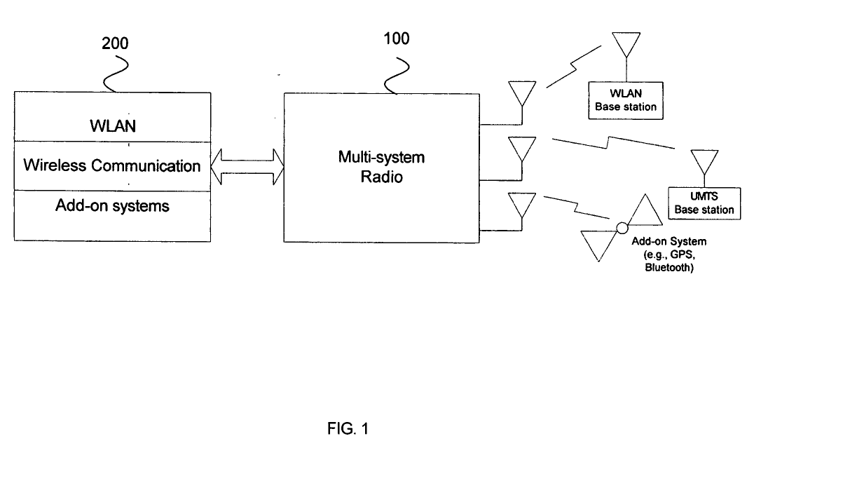

Turning now to FIG. 1, there is shown a block diagram of a multi-mode wireless communication system which may utilize circuits, systems and methods relating to certain embodiments of the present invention. As illustrated, a multi-system transmitter or transceiver 100 may be used by one or more applications 200 to communicate with one or more wireless networks such as a wireless network (e.g. WiFi-802.11a,b,g), a cellular network (e.g., UMTS), or additional networks (e.g. GPS or Bluetooth).

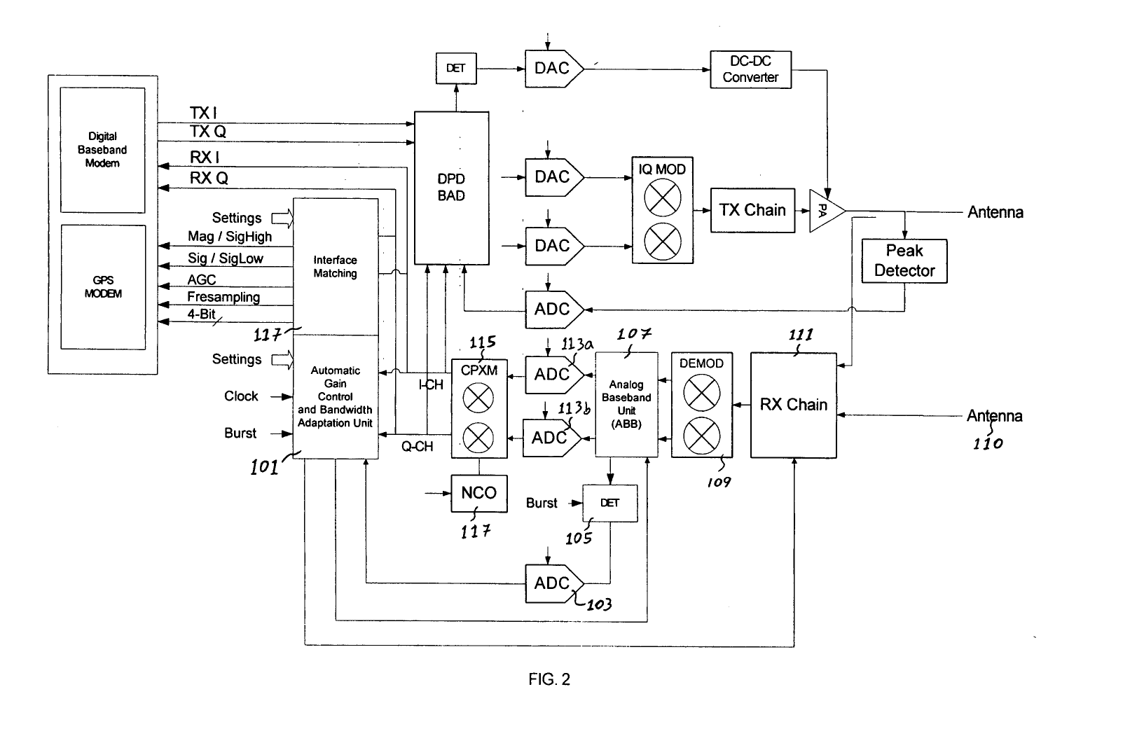

Turning now to FIG. 2, there is shown a block diagram of an exemplary radio or transceiver 100 including adaptive automatic gain control systems and circuits according to some embodiments of the present invention. According to some embodiment of the present invention, such as the embodiment shown in FIG. 2, an Automatic Gain Control and Bandwidth Adaptation Unit 101 (“AGC”) may receive indications of a received signal's strength either from a signal strength detector 105 connected to an Analog Baseband Unit 107, or from signals output from a complex demodulator 115. Analog-to-Digital Converters (“ADC”) 103, 113a and 113b may be used to convert analog signals into the digital domain and subsequently used by the AGC 101 to determine the amount of gain correction required by the Analog Baseband Unit 107 and/or by the RX Chain 111.

In response to received signal strength indications, the AGC 101 may issue a signal intended to cause one or more variable gain amplifiers to either boost or reduce the amount of amplification applied to the given received signal. A receive signal may pass through one or several variable gain amplifiers, either residing at various points along the receive signal path, including but not limited to inside the RX Chain 111 and/or inside the Analog Baseband Unit 107, or possibly residing somewhere external to the radio/transceiver circuit, possibly somewhere in front of the transceiver's 100 antenna, for example between the antenna 110 and the RX Chain 111 or before the antenna 110.

The AGC 101 may store, internally or in an associated external memory (not shown), the predefined instruction parameters or a set of parameters intended to place the AGC 101 in one of several possible operational configurations. Each operational configuration may be associated with a specific type of signal to be received. For example, a first instruction set may be intended to configure the AGC 101 so as to facility the amplification, acquisition and/or reception of a Universal Mobile Telecommunication System (“UMTS”) frame, while a second instruction set may be intended to configure the AGC 101 such that it is suitable to facility the amplification and reception of a WiFi beacon or data signal. The AGC 101 may operate according to a stored instruction set intended to adjust the gain factor of the variable gain amplification and/or to optimally receive any type or format of communication signal known today or to be devised in the future.

According to some embodiments of the present invention, including the exemplary embodiment shown in FIG. 2, a signal may be received via an antenna 110 and may enter an RX chain 111. The RX chain 111 may include one or more filters tuned to select one or more carrier frequencies of interest (i.e. frequencies associated with the one or more carrier signals of interest). The RX chain 111 may also include an amplifier, a preamplifier, a VGA, or some combination of all three. According to some embodiments of the present invention in which the RX chain 111 may include a coarse VGA, an AGC 101 may estimate the amount of correction required (e.g. amplification or reduction in amplification) and provide to the RX chain VGA with an appropriate value corresponding to the gain correction to be applied to the receive signal prior to demodulation. RX chains 111, including VGA's and filters, and demodulators are well known in the art of the communication. Any VGA's, filters, and demodulators known today or to be devised in the future are applicable to the present invention.

The output of an RX chain 111 may enter a demodulator 109, where one or more frequencies of interest may be down-converted to a lower frequency or otherwise demodulated. In the event that a signal of interest is comprised of multiple carrier signals having multiple carrier frequencies, each of the relevant carrier frequencies may be down-converted or otherwise demodulated.

An analog baseband unit 107 may include a variety of signal filters, including anti-aliasing filters, and may include one or more VGA's. Each of the one or more filters and/or VGA's may be associated with, or be in the receive signal path of, one or more signals of interest, such that a signal of interest (e.g. received signal), which may be comprised of one or more signal components or channels, will have to pass through one or more of the VGA's and/or filters in the analog baseband unit 107.

According to the example shown in FIG. 2, analog baseband unit 107 may contain separated VGA(s) and signal filter(s) for each of the channels (e.g. I channel and Q channel) of a complex demodulation process (e.g. QAM demodulation). According to some embodiments of the present invention, one or more VGA's in the analog baseband unit 107 may be functionally associated with AGC 101, such that the AGC 101 may calculate and provide gain correction values to the one or more VGA's to be used in amplifying a signal passing through each respective VGA and/or filter.

According to some embodiments of the present invention, separate channels or signals of a complex communication signal may be amplified by separate VGA's and each VGA may be provided with a separate and distinct gain value by the AGC 101. Given that the different channels associated with the same complex information signal may experience different attenuation along their respective signal paths, there is a condition referred to as amplitude mismatch between the signal paths. This condition of amplitude mismatch may occur when one of the real channels (I or Q channels) required for demodulation of a complex signal have experienced greater attenuation and/or amplification than another channel. The amplitude mismatch may affect the original symbol constellation of a complex signal by changing the radial distance from the sampling points to the origin, hence, reducing the minimum distance between the sampling points. This condition may contribute to a substantial increase of the probability of detecting wrongly the symbols and thus degrading the performance of the system. For the above stated reasons and others, according to some embodiments of the present invention, the AGC 101 may provide each VGA associated with each separate (in-phase and Quadrature) channel of a complex communication signal with a distinct gain value, wherein the gain values have been corrected so as to compensate for amplitude mismatch conditions.

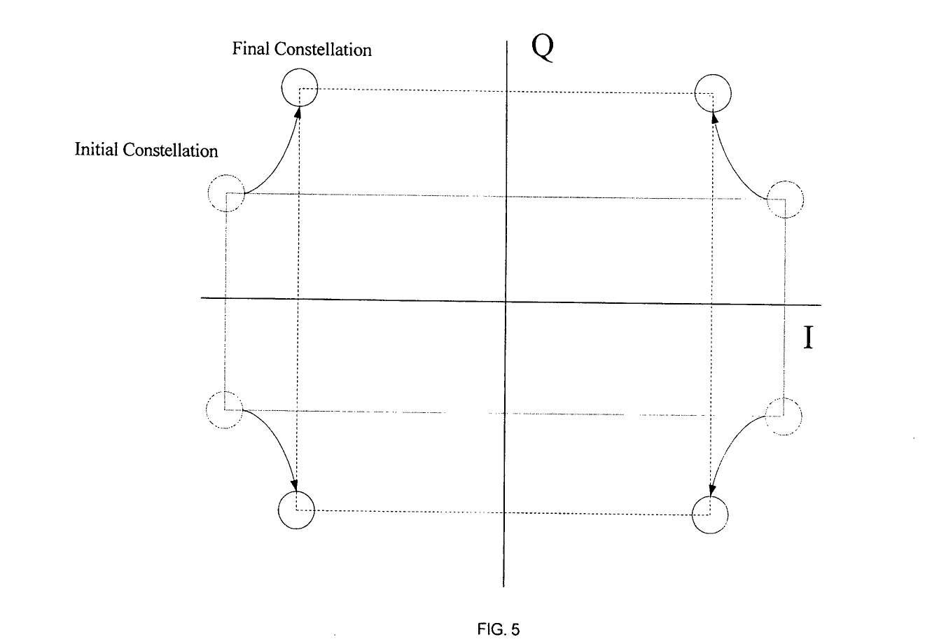

Turning briefly to FIG. 5, there is shown a graph of a complex plane onto which a constellation of symbols relating to a complex (e.g. Quadrature Phase Shift Keying Modulation) data signal may be mapped. Depicted in the graph of FIG. 5 is an adjustment or remapping which may be performed by an AGC 101 and two VGA's, to compensate for amplitude mismatching which may result from the different attenuation or amplification factors in the signal path due to mismatch between the existent components in the receiver chain channels. It should be noticeable that by adjusting the gain applied to each of the I and Q channels of the signal depicted in FIG. 5, the shape of the resulting symbol constellation may be corrected from a deformed constellation to a substantially square, provided that the original complex signal presents the same amount of gain in the I and Q components.

Now turning back to exemplary embodiment shown in FIG. 2, there is shown that a signal strength detector 105 may be connected or otherwise functionally associated with the analog baseband unit 107, such that it may detect an envelope, or some other feature indicative of the signal power, of the complex signal passing through the analog baseband unit 107. The detector 105 may be adapted to detect the strength of one or more components or channels of a complex signal along the amplification path, either before or after one or more of the VGA's in the analog baseband unit 107. According to some embodiments of the present invention, an analog-to-digital converter 103 may sample an output signal from the detector 105 and may provide a digital signal representation of the detector's output to the AGC 101.

According to an embodiment of present invention where the detector is adapted to detect the complex signal along amplification path before a VGA, the signal path between the detector 101 and the AGC 101 may be considered a feed-forward loop. Conversely, if a detector is configured to detect a signal after amplification by one or more VGA's, it may be considered part of a feedback loop. According to some embodiment of the present invention, a detector's point of connection to the analog baseband unit 107 may be adjustable during operation, such that the detector 105 may facilitate either a feed-forward and/or a partial feedback signal for the AGC 101. In the event that the analog baseband unit 107 is comprised of multiple VGA's, the detector 105 may be connected after one or more of the VGA's and it may provide a partial feedback loop. However, if the detector 105 is connected only prior to the one or more VGA's in the analog baseband unit 107, it may only provide a portion of the feed-forward loop.

The output of the analog baseband unit 107 may be sampled by one or more analog-to-digital converters (“ADC”), 113a and 113b, and the output of the converters may be provided to digital demodulator 115. The demodulator shown in the example of FIG. 2 is complex digital demodulator associated with a numerically controller oscillator 117. One of ordinary skill in the art should understand that the present invention is not limited to such demodulators, and that any demodulator presently known or to be devised in the future may be applicable to the present invention.

Output signals from the complex demodulator 115 may be provided to a digital baseband modem and may also be provided to the AGC 101. The AGC may sample the output of the digital demodulator 115 to estimate the signal level and to determine the amount of gain correction to be applied to each of the respective VGA's. The signal path between the digital demodulator and the output of the AGC 101 may be considered part of the feedback loop according to some embodiments of present invention.

According to a further embodiment of the present invention, the AGC may instruct one or more elements (e.g. filters) along the receive signal path to adjust their respective frequency response characteristics or bandwidth. Adjustment of the frequency response characteristics or bandwidth of one or more elements (e.g. filters) may be implemented in order to compensate for a shift in the overall frequency response of the receive signal path caused by a change in a gain factors associated with one or more VGA's. Thus, an AGC 101 according to some embodiments of the present invention may first cause gain value adjustments of one or more VGA's along the receive signal path in order to facilitate the acquisitions of a given signal, and then may cause bandwidth or frequency response adjustments to be implemented somewhere along the signal path in order to compensate for frequency response shifts resulting from the gain value adjustments. According to some embodiments of the present invention, the AGC 101 may be associated with a data table which may store corresponding gain adjustment and frequency response adjustment values for the receive path. According to some embodiments of the present invention an AGC 101 may estimate the frequency and bandwidth shifts caused by the adjustment of one or more gain values and may determine what bandwidth compensation factors or instructions to issue to one or more filters in the signal path. According to some embodiments of the present invention, an AGC 101 may store in a data table to bandwidth compensation factors or instructions associated with specific gain values.

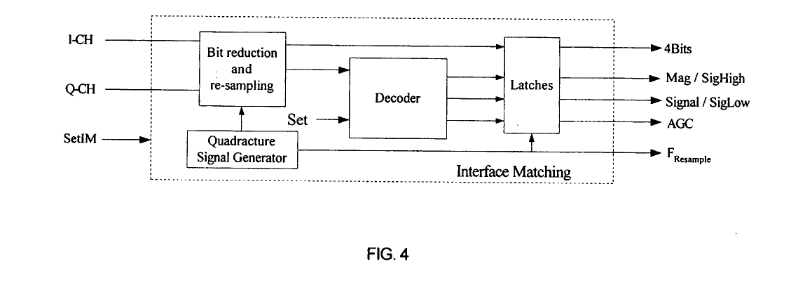

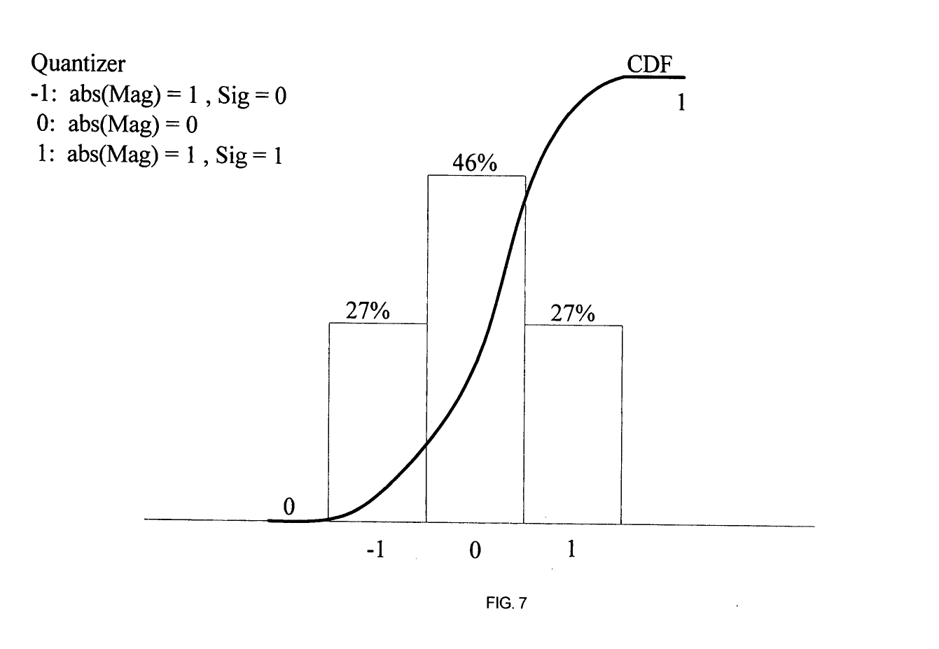

Also shown in the example of FIG. 2, is an interface matching unit 117 which may facilitate the use of the present invention with a Global Positioning System (“GPS”) digital baseband. Turning briefly to FIGS. 4 and 7, there are shown, respectively; (1) a block diagram of an exemplary interface matching sub-system according to some embodiments of the present invention, and (2) a graph illustrating signal quantization parameters for an interface matching subsystem according to some embodiments of the present invention. Most of today's GPS receivers operate with less than 4 bits of resolution in the ADC, as the signal degradation is negligible for higher resolution. The most common types of ADC interface configurations for commercial GPS receivers are based on ADCs with 1.5 bit or 2 bit resolution due to the resulting simplicity in the implementation of the digital baseband. In particular, the de-spreading (correlation) unit and power consumption constraints for such low bit resolution systems are relatively simple and low.

As bit resolution decreases, however, the importance of setting the received level (the received level is basically the noise level as the signal level is well below the noise level) at the optimum operation point of the ADC for minimum degradation of the carrier to noise ratio is crucial. FIG. 7 shows an exemplary distribution for 1.5 bit ADC with 3 levels of quantization. The probability of a sample to be present at the dead-zone equals to 46% for minimum degradation of the carrier to noise ratio due to the contribution of the quantization noise. The interface matching unit of FIG. 4 may provide adaptation of the high resolution I and Q channels to either 1.5 or 2 bits according to an external parameter (SET). The incoming I and Q signals may be first re-sampled in the interface unit 117 and then reduced to 2-bits resolution. The resultant digital signal may then be applied to a decoder which may map the initial digital representation into a commonly used signal representation for GPS receivers. The selection between 2-bits (four levels of quantization) and 1.5-bit (three levels of quantization) resolution may be governed according to the value of an external parameter. A 4-bit interface to the GPS baseband may also be provided. The re-sampling of the incoming digital signal may be performed at at least twice the data rate to avoid aliasing the replicas of the data in the desired bandwidth.

Parameters associated with an AGC's operational configuration include; (1) an update or sampling rate of the signal to be variable gain amplified, (2) the desired level to which a signal is to be amplified, and (3) the weight given to feedback and/or feed-forward loop(s) in determining a gain value. Each of the listed parameters may be a function of the type of signal to be amplified and the duration of the information or point of signal acquisition and/or reception during which the signal is being amplified. For each type of signal, the AGC 101 may use one set of parameters during initial signal acquisition and may switch to another set of parameters during the steady state reception of the signal, wherein the second set, one or more parameters may differ from the initial parameters.

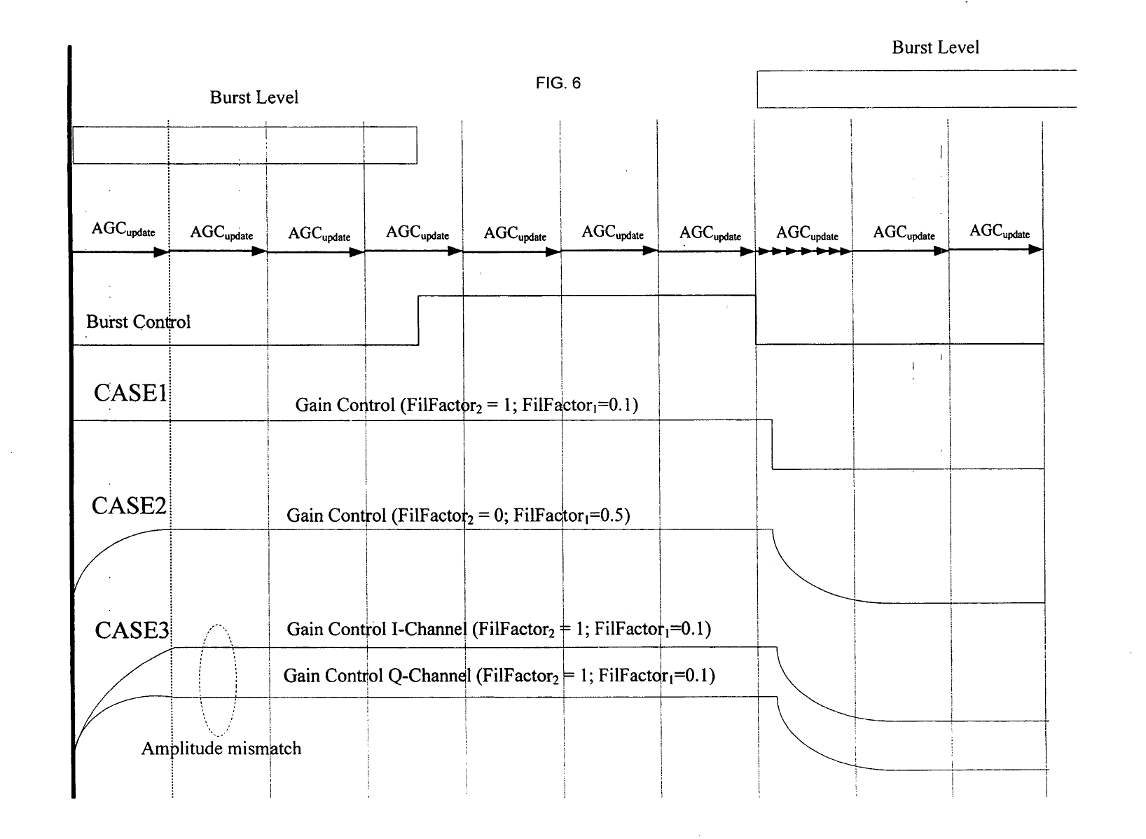

Specific examples of how an AGC's parameters may be adjusted or modified to accommodate different types of signals and different periods of reception for the same type of signal are provided below, and may be described in view of FIG. 6, which shows a time based graph illustrating the timing of various signals according to some embodiments of the present invention and during three separate signal acquisition and reception scenarios:
(1) UMTS Signals—UMTS receivers operating in FDD (frequency division duplex) mode show continuous reception of signal in normal operation, i.e., the detection of the complex signal is always present. In this operation mode, the feed-forward loop might remain inactive or have negligible contribution to the dynamics of the system as there is no need to detect short sequences to change drastically the AGC setting prior to the demodulation of a slot in cases the system needs to operate with discontinuous reception between two or more successive slots. Therefore, the feed-back loop could be used alone to settle the steady state of the AGC in systems experiencing continuous reception (detection) of the data signal and slow variations in the signal level. The combination of parameters as the weighing factor and the update rate defines the dynamic of the loop and its amount of noise suppression.
(2) WLAN Signals—The WLAN system as 802.11a, unlike the UMTS, requires the detection of short sequences, usually with the few microsecond range, for the detection of the signal and correction by the AGC loop. For short detection cycles, the feed-forward loop plays a major role as the correction factor may vary almost immediately with the level of the received signal. To realize corrections within few microseconds the update interval of the loop must be decreased below the defined interval in order to bring the AGC correction to the vicinity of the steady state condition. In this mode of operation, the feed-forward loop dominates the dynamics of the loop during the initial acquisition/detection of the training structure. Eventually, the dynamics of the AGC loop may change during the reception of the rest of the data, i.e., the contribution of the feed-forward and feedback loops to the dynamics of the AGC might change.
(3) GPS—GPS gain control systems (AGC's) must provide an optimum loading factor to the analog to digital converter, particularly for ADC's having low resolution as normally encountered in real world. The detected value can be extracted simply from the magnitude of the complex signal, and the correction factor obtained by comparing the estimate against the desired (the reference) value. The dynamics of the AGC can be seen akin to the dynamics of the feedback loop. Either the internal AGC 101 or the AGC information can be provided to an external circuitry to generate the appropriate correction factor.

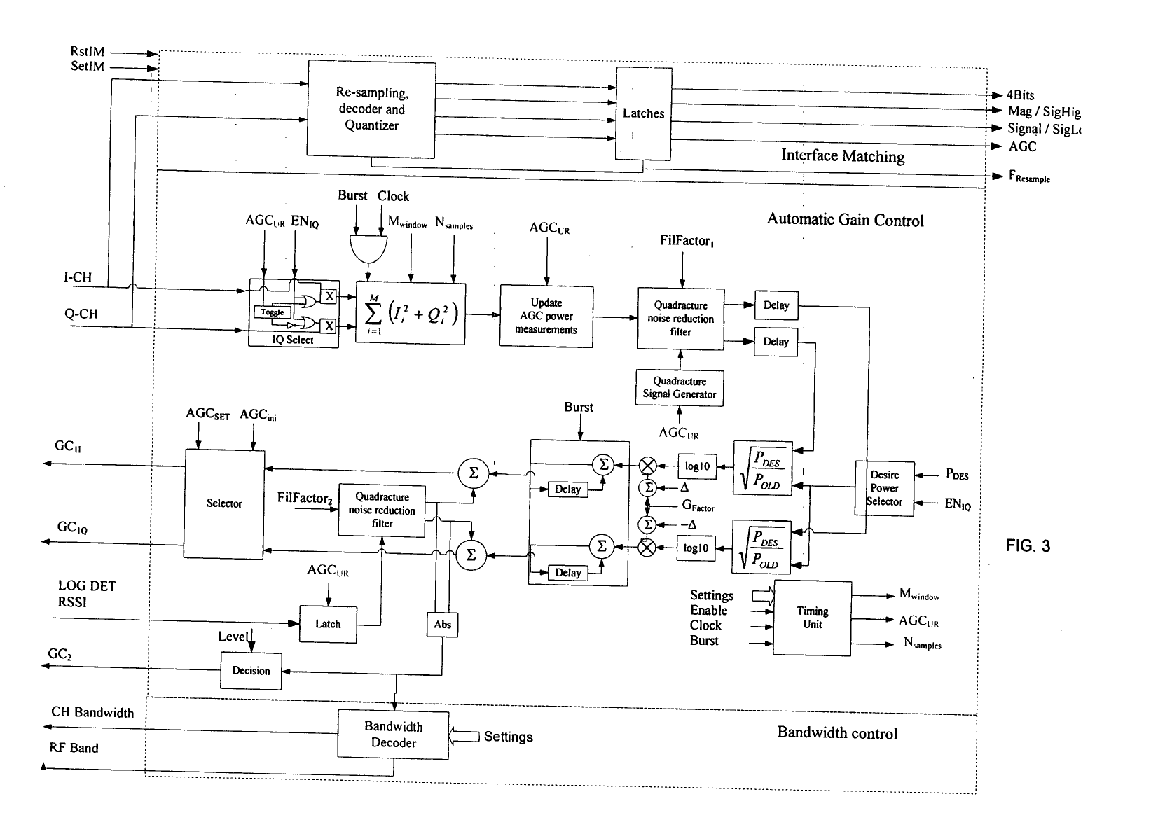

Turning not to FIG. 3, there is shown a block diagram of the automatic gain control system, an associated bandwidth control sub-system and associated interface matching subsystem according to some embodiments of the present invention. The AGC 101 shown in FIG. 3. may be a fully configurable AGC having dynamics using parameterized noise reduction filter, a variable timing structure and a gain adjust of the reverse path. The AGC 101 may have the ability to provide a gain correction factor either based on measurements of a real channel (I or Q channel) or the complex channel. The AGC may support either internal calibration of the I and Q amplitude imbalance or external calibration may be provided by using a training sequences. Separate gain correction factors for gain control of multiple VGA units associate with separate channels may also be provided. The Interface matching unit 117 may support reduction and re-sampling of a digitalized signal, and may provide an output signal for coupling to an external analog gain control unit for interfacing with existent GPS basebands.

The automatic gain control subsystem of FIG. 3 are comprised of an IQ select unit, a power measurement unit, an AGC update unit, noise reduction filters, and a quadracture control signal generator. The IQ select unit may provide the flexibility of selecting either the I channel, the Q channel or both (I and Q channels) for subsequent processing in the power measurement unit. The output of the power measurement unit may be the square of the magnitude of the complex signal. The number of samples accumulated in the power measurement unit and the measurement interval may be defined according to external parameters and waveforms delivered by a timing unit. A new updated value may be provided in every AGC update interval by an AGC update rate unit. The output of the AGC update rate unit may then be filtered and divided into two paths, representing the estimated power in the I and Q channels. For example, separate measurements of the I and Q channels might be applied to delay units of each of the individual branches. Conversely, the magnitude of the signal at the input of the delay units at the I and Q branches respectively might be the same for measurements of the magnitude of the complex signal in the situation where both channels are selected. The square-root and log units offer a comparison between the estimated and the desired values, with outputs applied to an accumulator unit. The signal at the output of the accumulator may be the correction factor for the feedback loop. Additional parameters may be added in the reverse path to adjust the gain of the reverse path and to correct for the amplitude imbalance in the receiver chain using an external training sequence. Similarly to the feedback loop, a noise reduction filter unit may be located at the feed-forward path to filter the detected signal originating from the unit.

One of ordinary skill in the art should understand that the described invention may be used for all kinds of wireless and/or wire based systems, including but not limited to Tower Mounted Amplifier, wireless, wire, cables or fiber servers where a narrow interference has to be filtered out, and where phase linearity and filter parameters may be software programmable.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of receiving a communication signal comprising:
selecting one or more from a set of possible signal types to receive;
adjusting one or more parameters of an automatic gain control unit to correspond to the selected one or more signal types; and
providing one or more gain correction factors from the automatic gain control unit to one or more variable gain amplifier units.

2. The method according to claim 1, wherein adjusting an automatic gain control unit comprises adjusting weighting factors associated with a feed-forward and/or feed-back loop.

3. The method according to claim 2, wherein adjusting an automatic gain control unit further comprises adjusting a signal sampling and/or gain factor update rate of the automatic gain control unit.

4. The method according to claim 1, comprising determining an initial gain correction factor by reading an initial sequence of information associated with the received signal.

5. The method according to claim 3, further comprising reducing the sampling rate and/or gain factor update rate of the automatic gain control unit once an initial period of detection is completed.

6. The method according to claim 1, further comprising adapting the frequency response of one or more elements in the received signal path.

7. The method according to claim 6, wherein adapting the frequency response of one or more elements in the received signal path is performed either in concert or shortly after providing one or more gain correction factors.

8. The method according to claim 1, wherein a first set of gain correction factors applied to the one or more variable gain amplifier is derived from an initial received signal and primarily based on dynamics of a feed-forward loop, while a second set of gain correction factors are based on a combination of the dynamics of a feed-back and feed-forward loops or solely based on the dynamics of the feed-back loop.

9. The method according to claim 1, wherein the one or more of the gain correction factors from the automatic gain control unit may be provided to a variable gain amplifier unit positioned at different frequency stages in the receive signal path.

10. The method according to claim 1, wherein the one or more of the gain correction factors from the automatic gain control unit may be provided to a one or more variable gain amplifier units, and wherein each of the one or more variable gain amplifier units is adapted to amplify a different channel of a complex communication signal.

11. The method according to claim 10, wherein one or more of the gain correction factors from the automatic gain control unit are determined so as to correct for an amplitude imbalance between two more channels of a complex communication signal.

12. The method according to claim 1, further comprising interface matching for a GPS modem.

13. A circuit for receiving a communication signal comprising:
an automatic gain control unit including one or more adjustable operational parameters, wherein said one or more operational parameters may be adjusted corresponding to a signal type selected from a set of one or more signal types.

14. The circuit according to claim 13, wherein each of the one or operational parameter may be selected from the group consisting of feedback loop weighting factor, feed-forward loop weighting factor, sampling rates associate with the feedback and feed-forward loop, gain value update rate of a first variable gain amplifier, gain value update rate of a first variable gain amplifier for a second variable gain amplifier, and target signal output power values.

15. The circuit according to claim 14, further comprising one or more variable gain control units, and wherein said automatic gain control unit is adapted to provide said one or more variable gain control units one or more gain correction factors.

16. The circuit according to claim 14, where said automatic gain control unit is adapted to determine an initial gain correction factor by reading an initial sequence of information associated with a received signal.

17. The circuit according to claim 16, wherein said automatic gain control unit is adapted to reduce a sampling rate and/or gain factor update rate once an initial period of detection is completed.

18. The circuit according to claim 14, wherein said automatic gain control unit adapts a frequency response of one or more elements in the received signal path.

19. The circuit according to claim 18, wherein said automatic gain control unit adapts a frequency response of one or more elements in the received signal path either in concert or shortly after providing one or more gain factors.

20. The circuit according to claim 19, wherein one or more of the gain factors from the automatic gain control unit are determined so as to correct for an amplitude imbalance between two or more channels of a complex communication signal.
